(19) United States
(12) Patent Application Publication
(10) Pub. No.: US 2014/0156446 A1
(43) Pub. Date: Jun. 5, 2014

(54) METHOD OF SELLING A CUSTOM PRODUCT AS AN OVER-THE-COUNTER COMMODITY ITEM

(71) Applicants: Timothy R. McGrath, Lynnwood, WA (US); Patrick T. Moore, Mountlake Terrace, WA (US)

(72) Inventors: Timothy R. McGrath, Lynnwood, WA (US); Patrick T. Moore, Mountlake Terrace, WA (US)

(73) Assignee: QMM, LLC, Everett, WA (US)

(21) Appl. No.: 13/960,578

(22) Filed: Aug. 6, 2013

Related U.S. Application Data
(62) Division of application No. 13/229,484, filed on Sep. 9, 2011, now abandoned.
Application No. 13/229,484 is a continuation of application No. 11/937,329, filed on Nov. 8, 2007, now abandoned.
(60) Provisional application No. 60/865,133, filed on Nov. 9, 2006.

(51) Int. Cl. G06Q 30/06

(52) U.S. Cl. CPC G06Q 30/0621
USPC 705/26.5

(57) ABSTRACT

The present disclosure provides a method of selling a supplier's product to a consumer, wherein the method includes providing a physical representation of a product to the consumer. The physical representation includes a temporarily concealed first unique identifier corresponding to the physical representation of the product. The method further includes selling the physical representation to the consumer, providing a network location to the consumer for facilitating the redemption of the product with the first unique identifier, and shipping the product to the consumer.

### CROSS-REFERENCES TO RELATED APPLICATIONS

This application is a division of U.S. patent application Ser. No. 13/229,484, filed Sep. 9, 2011, which is a continuation of U.S. patent application Ser. No. 11/937,329, filed Nov. 8, 2007, which claims the benefit of U.S. Provisional Application No. 60/865,133, filed Nov. 9, 2006, the disclosures of which are hereby expressly incorporated by reference herein in their entirety.

### BACKGROUND

Customizable products, such as name plates or registration plates for boats, are often sold through a retail store or sold directly from the supplier over the Internet. For instance, to order a registration plate from a retailer, such as a marine shop, a consumer must provide the retailer with all the necessary information, such as the registration number and consumer contact information. The retailer must inquire about the cost of the product, which may entail looking through a product catalog or contacting the supplier to obtain a quote. The retailer must thereafter place the order with the supplier and handle all issues with the supplier. This is time consuming and inefficient, and may even be cost-prohibitive to selling the items in the store.

Selling items over the Internet is a more efficient method of selling customized products since the consumer can provide all his customized information directly to the supplier by entering his information on the supplier's Web site. It is likewise a more efficient and environmentally safe way of selling digital products, such as music and software, since hardcopies of the product are eliminated and the selection is virtually unlimited. However, to purchase an item over the Internet, the consumer must enter his personal contact information and credit card information, which exposes the consumer to security theft and fraud. Moreover, items for sale over the Internet cannot be displayed in a retail store, which is where consumers often want to go to learn about the various products and purchase the product.

Thus, it is desired to have an efficient manner of displaying and selling a product in a retail store that enables the consumer to provide the supplier with his choice of product and/or his customized information without requiring the consumer to enter his personal information on a Web site.

### SUMMARY

The present disclosure provides a method of selling a supplier's product to a consumer, wherein the method includes providing a physical representation of a product to the consumer. The physical representation includes a temporarily concealed first unique identifier corresponding to the physical representation of the product. The method further includes selling the physical representation to the consumer, providing a network location to the consumer for facilitating the redemption of the product with the first unique identifier, and shipping the product to the consumer.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the present disclosure will become more readily appreciated by reference to the following detailed description, when taken in conjunction with the accompanying drawings, wherein:

FIG. 1 is a front isometric view of a physical representation of a product constructed in accordance with one aspect of the present disclosure;

FIG. 2 is a rear isometric view of the physical representation of FIG. 1 shown in the open position;

FIG. 3 is a side cross-sectional view of the physical representation of FIG. 1 shown in the open position, wherein an insert portion is shown being received within a package portion;

FIG. 4A is a partial front view of the insert portion of the physical representation of FIG. 3;

FIG. 4B is a partial front view of the insert portion of the physical representation of FIG. 3, wherein the insert portion is shown inverted for clarity;

FIG. 5 is an interior view of the insert portion of the physical representation of FIG. 3;

FIG. 6 is an exemplary pictorial depiction of a networking environment for carrying out aspects of the present disclosure, wherein the networking environment includes a retail server, a supplier server, and a plurality of client computers;

FIG. 7 is a an exemplary pictorial depiction of a computer architecture for the supplier server depicted in FIG. 6;

FIG. 8 is an exemplary flow diagram of a method for selling a custom product as an over-the-counter commodity item;

FIG. 9 is an exemplary pictorial depiction of a first Web page suitable for carrying out aspects of the method shown in the flow diagram of FIG. 8;

FIG. 10 is an exemplary pictorial depiction of a second Web page suitable for carrying out aspects of the method shown in the flow diagram of FIG. 8;

FIG. 11 is an exemplary pictorial depiction of a third Web page suitable for carrying out aspects of the method shown in the flow diagram of FIG. 8; and

FIG. 12 is an exemplary pictorial depiction of a fourth Web page suitable for carrying out aspects of the method shown in the flow diagram of FIG. 8.

### DETAILED DESCRIPTION

The present disclosure is directed to a method for selling a customizable product as an over-the-counter product in a retail store. Aspects of the present disclosure will be hereinafter described as selling customizable boat number plates, boat registration plates, and boat name plates (hereinafter generally referred to as “boat name plates”); however, it should be appreciated that the method described below can be used to sell any suitable product. Moreover, the steps for performing the method, as well as the means for implementing the method, may be modified without departing from the spirit and scope of the present disclosure.

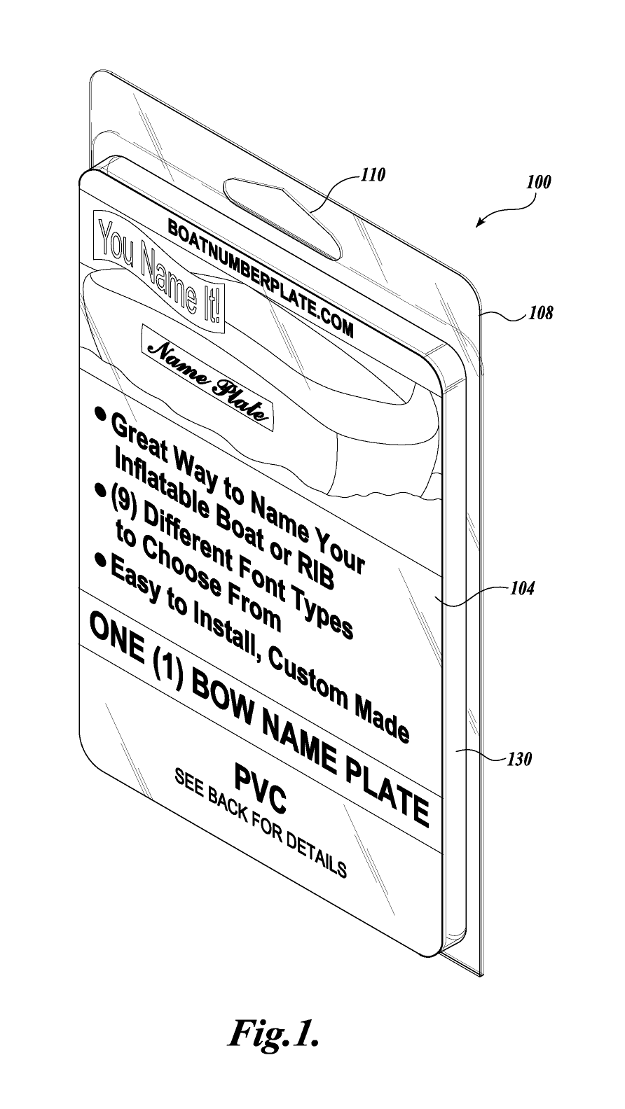

Referring to FIG. 1, the method for selling a customizable product as an over-the-counter item includes providing a physical representation of the customizable product that can be sold in a retail store for a predetermined value. The physical representation of a customizable product is embodied as a packaged coupon 100 having an insert 104 displayed within a sealed package such as a well-known plastic clamshell 108 or any other suitable packaging.

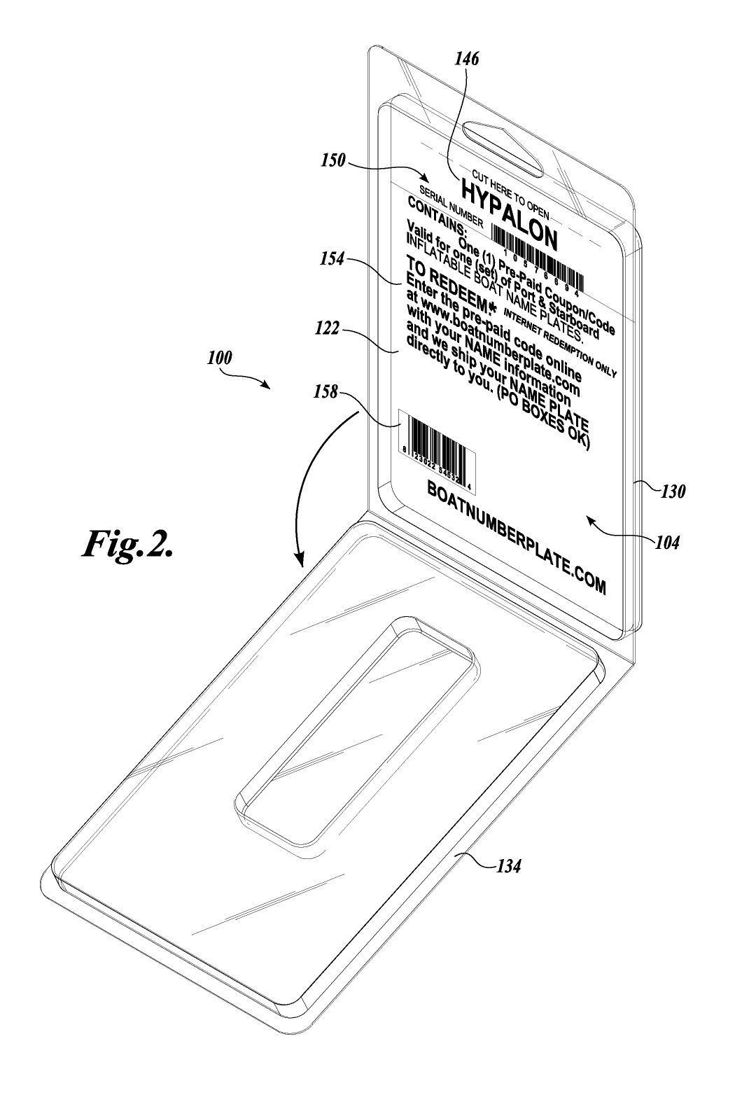

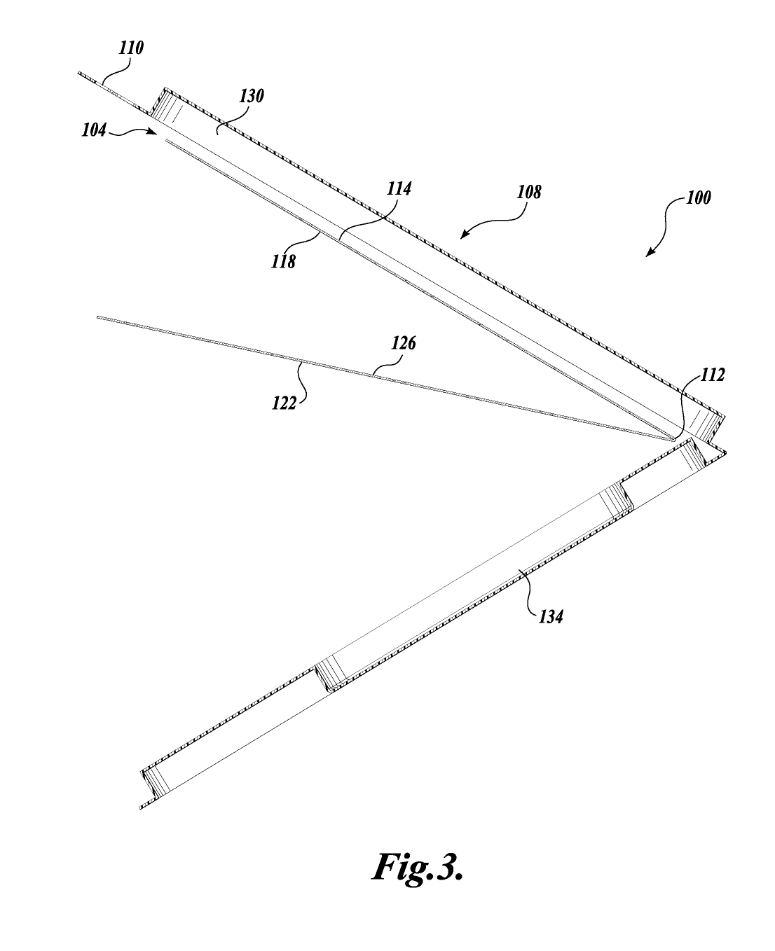

Referring to FIGS. 1-3, the clamshell 108 receives the insert 104 between a front side 130 and a back side 134 and is thereafter sealed around the edges to secure the insert 104 within the clamshell. The clamshell 108 is preferably heat sealed around its edges such that a user must cut the clamshell 108 to access the insert 104, thereby preventing theft of the insert 104 when the packaged coupon 100 is on display. The clamshell 108 includes a hanger 110 for hanging the packaged coupon 100 on any hook suitable for displaying the packaged coupon 100, such as a pegboard or a retail display case.

The insert 104 is preferably a piece of paper or any other suitable material that can receive printed data thereon, and is preferably substantially rectangular in shape or any other suitable shape that can be folded about a centerline 112 to be received within the clamshell 108. Thus, when folded in half, the insert 104 includes an upper front side 114, an upper back side 118, a lower front side 122, and a lower back side 126. The insert 104 is received within the clamshell 108 such that the upper front side 114 is displayed through the front side 130 of the clamshell 108, and the lower front side 122 of the insert 104 is displayed through the back side 134 of the clamshell 108.

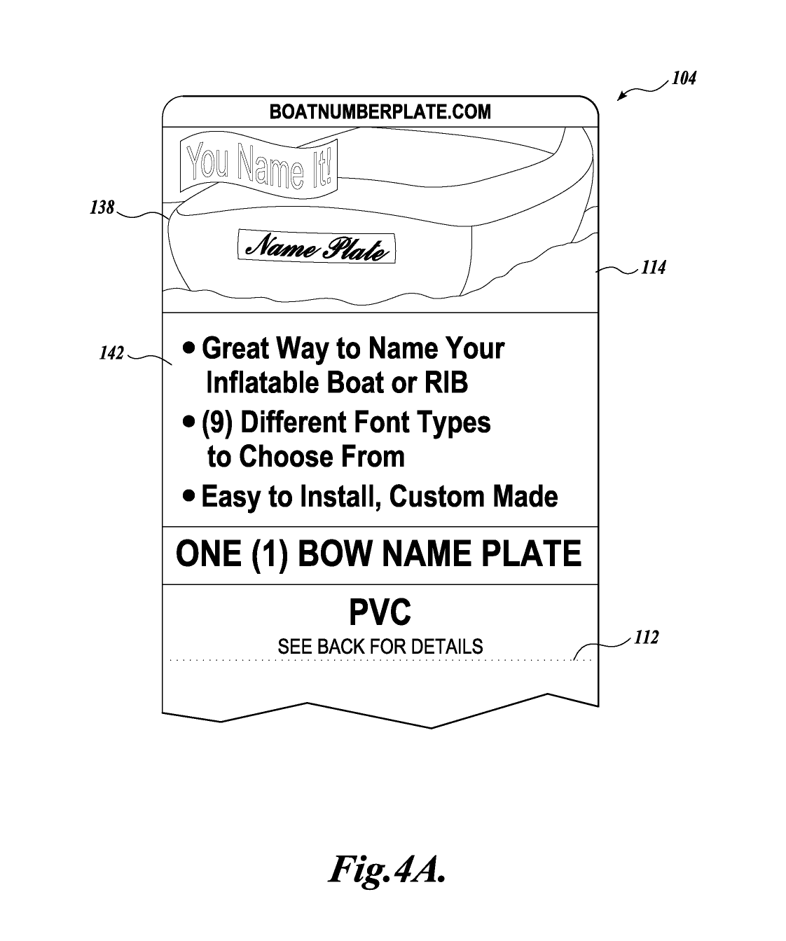

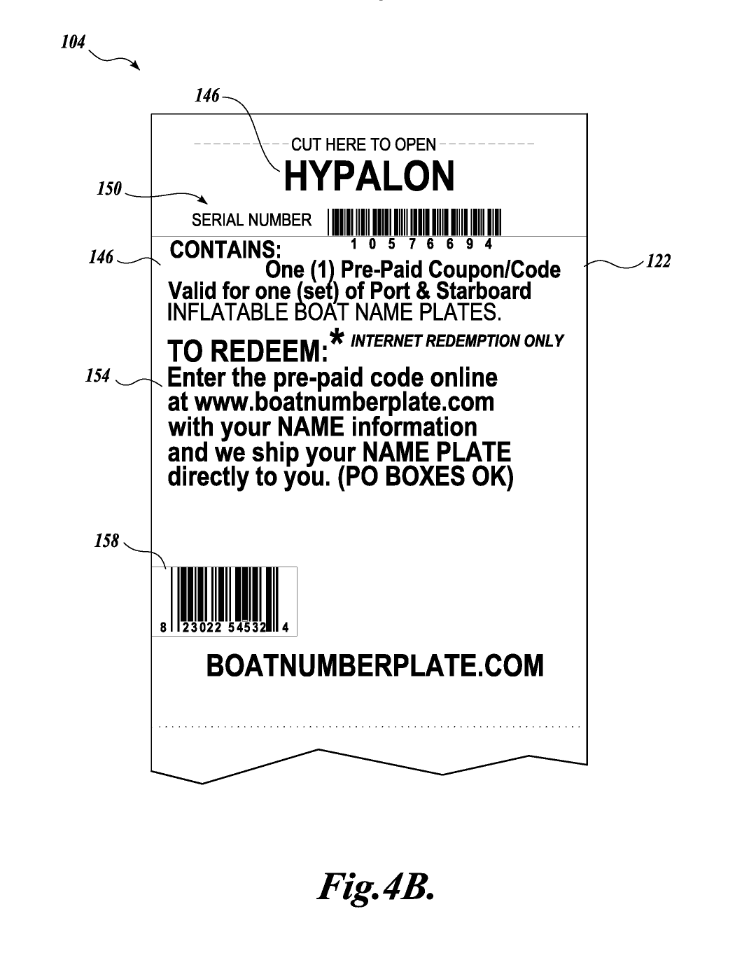

Referring to FIG. 4A, the upper front side 114 of the insert 104 may include illustrations, text, etc., that indicate the type of customizable product redeemable with the packaged coupon 100. For example, the upper front side 114 may include graphics 138 that illustrate the redeemable product and text 142 that provides information about the customizable product. For instance, if the customizable product represented by the packaged coupon 100 is a name plate for an inflatable boat, the graphics 138 may display an inflatable boat having the customized name plate secured thereto. The text 142 provided below the graphics 138 may include information about the types of inflatable boats on which the name plate may be used, the available colors, or other features that may be desirable to a consumer when purchasing the packaged coupon 100.

Referring to FIG. 4B, the lower front side 122 of the insert 104 may include further information about the customizable product. Although FIG. 4B depicts the information on the lower front side 122 as right side up, it should be appreciated that the information will instead be upside down such that when the insert 104 is folded about the center line 112, the information on the lower front side 122 is right side up when displayed within the clamshell 108. The information displayed on the lower front side 122 may include an indication of product type 146 printed at the top of the lower front side 122, which may be, for instance, the type of inflatable boat that may be used with the boat name plate.

Also displayed on the lower front side 122 is a serial number 150 that may be barcoded for scanning purposes and that is used to identify the specific packaged coupon 100. The serial number 150 is a unique identifier that corresponds to the packaged coupon 100 that can be used by both a supplier and a retailer to track the shipment of the packaged coupon 100 or to track the inventory of the packaged coupons 100 at the retail level. Further included on the lower front side 122 are general instructions 154 for redeeming the customizable product with the packaged coupon 100. The lower front side 122 may also include a retail identifier 158, such as a Universal Product Code (UPC), that is used for identifying the type of product at the retail level. For instance, the UPC 158 may identify that a packaged coupon 100 is for a boat name plate for a Hypalon inflatable boat.

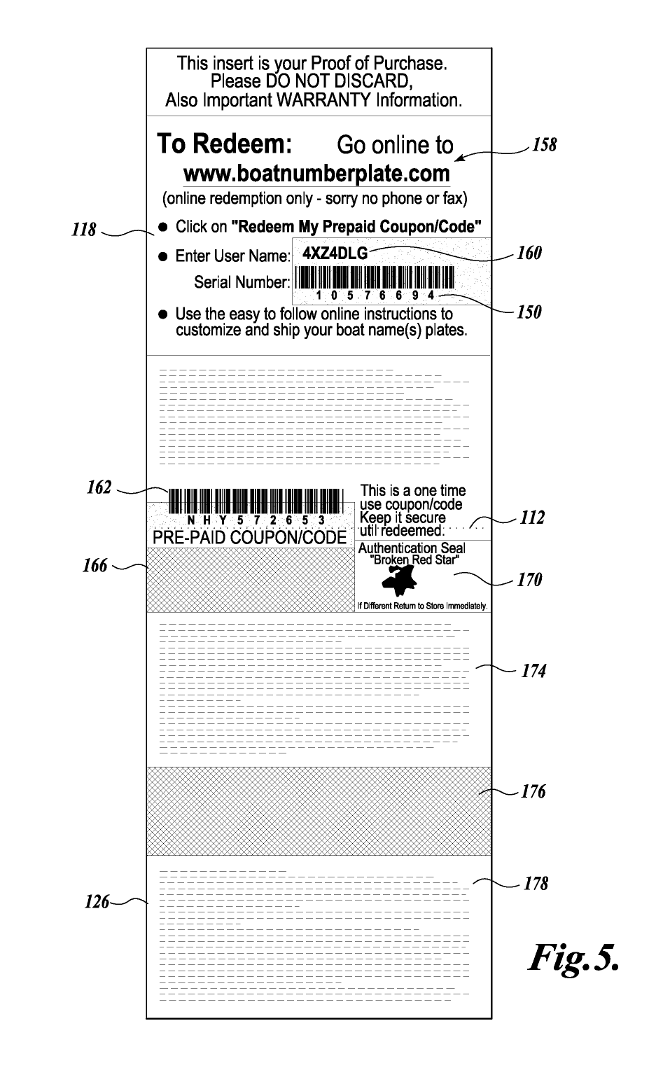

Referring to FIG. 5, the upper back side 118 of the insert 104 includes detailed information 158 for redeeming the customizable product 158. The information 158 includes instructions for accessing a Web site and entering an alphanumeric user name 160 and serial number 150 (wherein the serial number 150 is also displayed on the lower front side 122 of the insert 104). The user name 160 and/or the serial number 150 may be barcoded for convenience. The upper back side 118 further includes an alphanumeric coupon code 162 that may also be barcoded for convenience. The coupon code 162 is preferably positioned at the bottom of the upper back side 118 near the centerline 112 such that it may be covered by a block-out portion 166 printed on the lower back side 126 of the insert 104 when the insert 104 is folded about the centerline 112.

The lower back side 126 further includes a second block-out portion 176 printed thereon and positioned to cover the user name 160 and serial number 164 when the insert 104 is folded about the centerline 112. The first and second block-out portions 166 and 176 insure that the user name 160, serial number 164, and coupon code 162 are not visible through the lower back side 126 of the insert 104 when packaged within the clamshell 108. The lower back side 126 further includes an authentication seal 170 that is colored and uniquely shaped to indicate the originality of the packaged coupon 100, thereby preventing an unauthorized person from returning a copied version of a packaged coupon 100 or otherwise misusing the packaged coupon 100. The lower back side 126 also includes warranty information 174 for the customizable product and return or refund information 178 for the customizable product.

It should be appreciated that the foregoing description of the insert 104 is for illustrative purposes only, and the insert 104 may instead include any other suitable information for selling and redeeming the customizable product. Moreover, the insert 104 may be any other suitable design that covers the user name 160, serial number 150, and coupon code 162 when packaged within the clamshell 108.

The packaged coupons 100 are preferably made by the supplier of the customizable product; however, a third party may instead make the packaged coupon 100 and manage all aspects of redeeming the customizable product for the supplier. For the sake of clarity, the supplier of the packaged coupon 100 and the customizable product will hereinafter be referred to generally as “supplier.” The supplier generates the user name 160, the serial number 150, and coupon code 162 through any suitable means, such as with a database application like Microsoft® Access.

The user name 160, serial number 150, and coupon code 162 are generated as unique identifiers for each packaged coupon 100, and they are stored in a suitable database. The combinations of user names 160, serial numbers 150, and coupon codes 162 for each packaged coupon 100 are activated within the database for redemption of the customizable product. It should be appreciated that fewer or more than three unique identifiers may be created for each packaged coupon 100. The user name 160, serial number 150, and coupon code 162 are inactivated in the database when either the customizable product is redeemed or the packaged coupon 100 is stolen. The user name 160, serial number 150, and coupon code 162 may be automatically inactivated when the consumer accesses the supplier Web site to redeem the customizable product or when the retailer reports a specific serial number of a packaged coupon 100 as stolen.

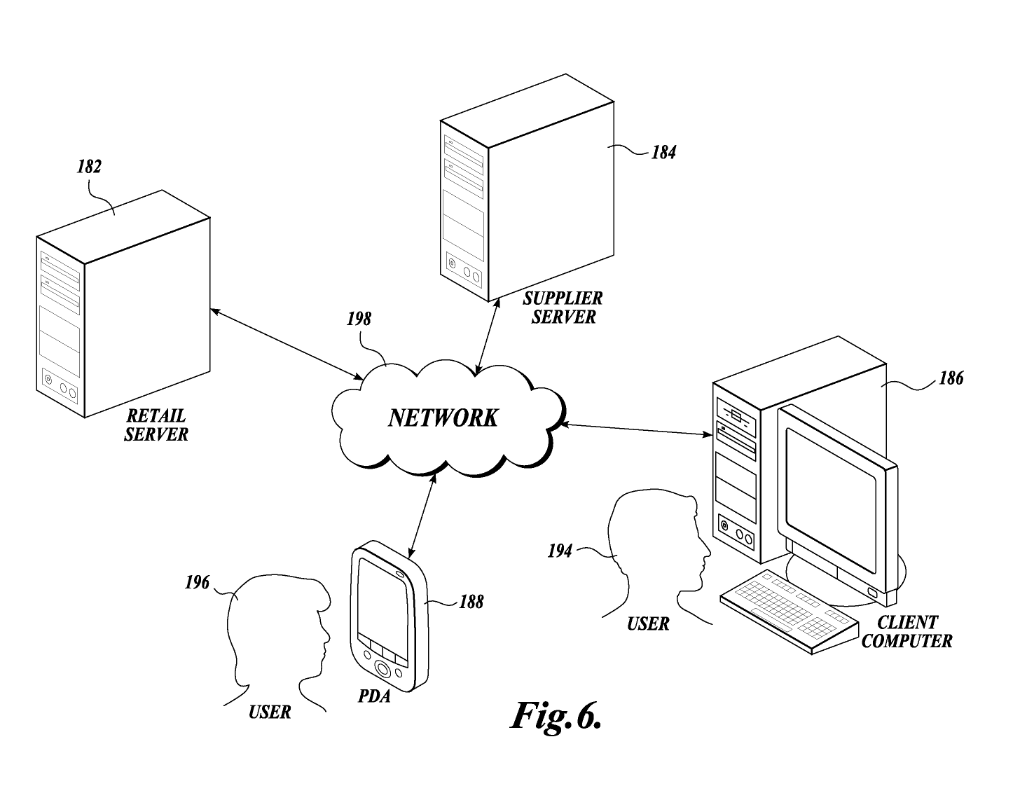

Referring to FIG. 6, a brief, general description of a networking environment 180 suitable to implement the method for selling a customizable product as an over-the-counter item will be described. It should be appreciated that the networking environment 180 hereinafter described is provided for illustrative purposes only. Moreover, although specific system configurations are illustrated, it should be understood that examples provided herein are not exhaustive and do not limit the present disclosure to the precise forms disclosed. Persons having ordinary skill in the field of computers will recognize that components described herein may be interchangeable with other components or combinations of components and still achieve the benefits and advantages of the disclosed method. The computer components hereinafter described may be grouped in a single location or distributed over a wide area.

The networking environment 180 is comprised of a plurality of computers, namely, the retail server 182, the supplier server 184, the client computer 186, and the personal digital assistant (“PDA”) 188. Moreover, the client computer 186 and the PDA 188 are shown associated with users 194 and 196, respectively. In any event, the retail server 182 and the supplier server 184 are configured to communicate with each other and with the client computer 186 and the PDA 188 via a network 198, which may be implemented as a local area network (“LAN”), a wide area network (“WAN”), or the global network commonly known as the Internet. As known to those skilled in the art and others, the computers 182, 184, 186, and 188 illustrated in FIG. 5 may be configured to exchange files, commands, and other types of data over the network 198. However, since protocols for network communication such as TCP/IP are well known to those skilled in the art of computer networks, those protocols will not be described herein.

The functions performed by the computers described with reference to FIG. 5 may instead be implemented by a plurality of computers. For example, while the supplier server 184 is illustrated as a single computer, server-based functionality is frequently handled in a “server farm” in which multiple servers cooperate in executing necessary tasks so that requests from potentially large numbers of users may be satisfied. Moreover, in addition to the conventional computer systems illustrated in FIG. 5, those skilled will recognize that the present method may be practiced on other kinds of computers, including laptop computers, tablet computers, or any other suitable device on which computer software or other digital content may be executed.

In the context of FIG. 6, the retail server 182 may be configured to store a list of the serial numbers of packaged coupons 100 purchased by a retailer. Upon receiving a shipment of new packaged coupons 100, the retailer may receive a hard copy listing of the serial numbers of the new packaged coupons 100 with the shipment. The retailer may use this list of serial numbers and manually input the serial numbers into a database stored on the retail server 182. The retailer may instead scan the serial numbers 150 displayed on the insert 104 with a suitable scanner to upload the serial numbers to the database on the retail server 182. The serial number information may be communicated from the retail server 182 to the supplier server 184 through the network 198 to provide added benefits to the retailer. For instance, the supplier may track the inventory of packaged coupons 100 at the retailer to generate automatic purchase orders for a new shipment of packaged coupons 100.

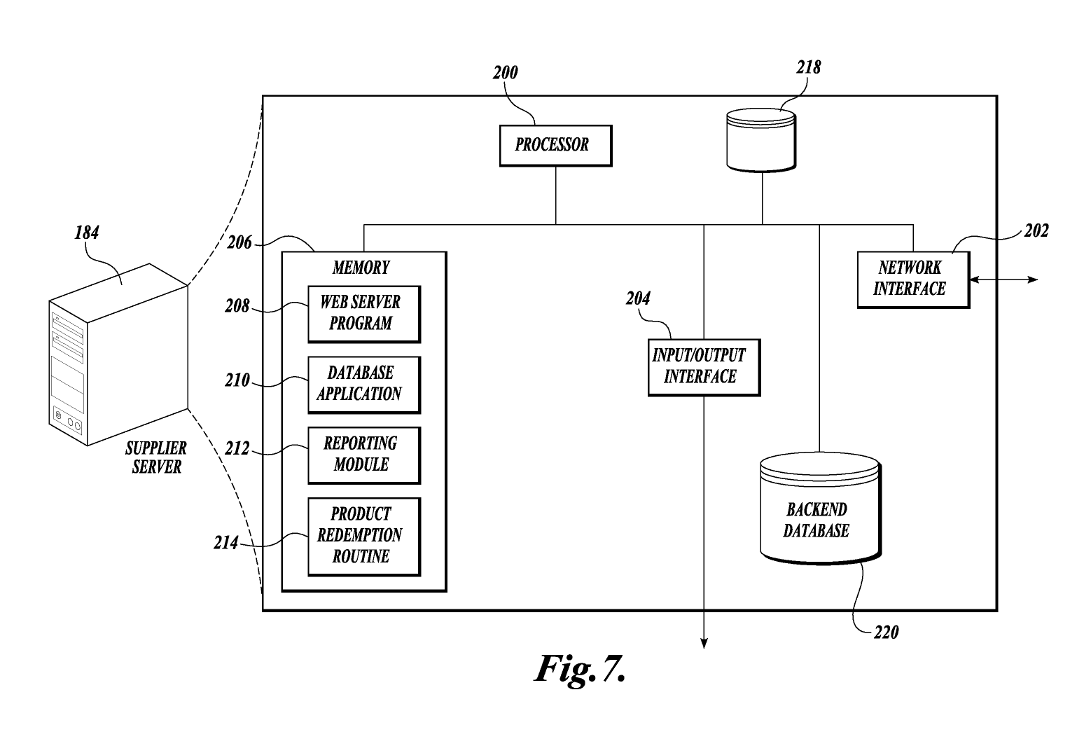

Now referring to FIG. 7, an exemplary architecture of the supplier server 184 depicted in FIG. 6 that illustrates computer components suitable to implement aspects of the present method will be described. Those skilled in the art and others will recognize that the supplier server 184 illustrated in FIG. 7 may be any one of a variety of devices including, but not limited to, personal computing devices, server-based computing devices, mini and mainframe computers, laptops, or other electronic devices having some type of memory. In the embodiment illustrated in FIG. 7, the supplier server 184 includes a processor 200 in communication with a variety of computing elements, including a network interface 202, an input/output interface 204, and a memory 206.

The network interface 202 depicted in FIG. 7 enables the supplier server 184 to communicate data, control signals, requests, and other information via a communication network (LAN, WAN, Internet, etc.) such as the network 198 described above with respect to FIG. 6. For instance, the supplier server 184 may receive requests from other networked computers and transmit data back to a requesting computer using the network interface 202.

The input/output interface 204 enables the supplier server 184 to communicate with various local input and output devices. An input device in communication with the input/output interface 204 may include computing elements that provide input signals to the supplier server 184, such as a keyboard, mouse, external memory, disk drive, etc. Also, an output device in communication with the input/output interface 204 may include computing elements that accept output signals such as a monitor, a printer, and the like.

The processor 200 is configured to operate in accordance with computer program instructions stored in a memory, such as the memory 206. In some computing systems, program instructions may also be embodied in a hardware format, such as a programmed digital signal processor. In any event, as illustrated in FIG. 7, the memory 206 stores a Web server program 208, a database application 210, a reporting module 212, a product redemption routine 214, and a service handler 216.

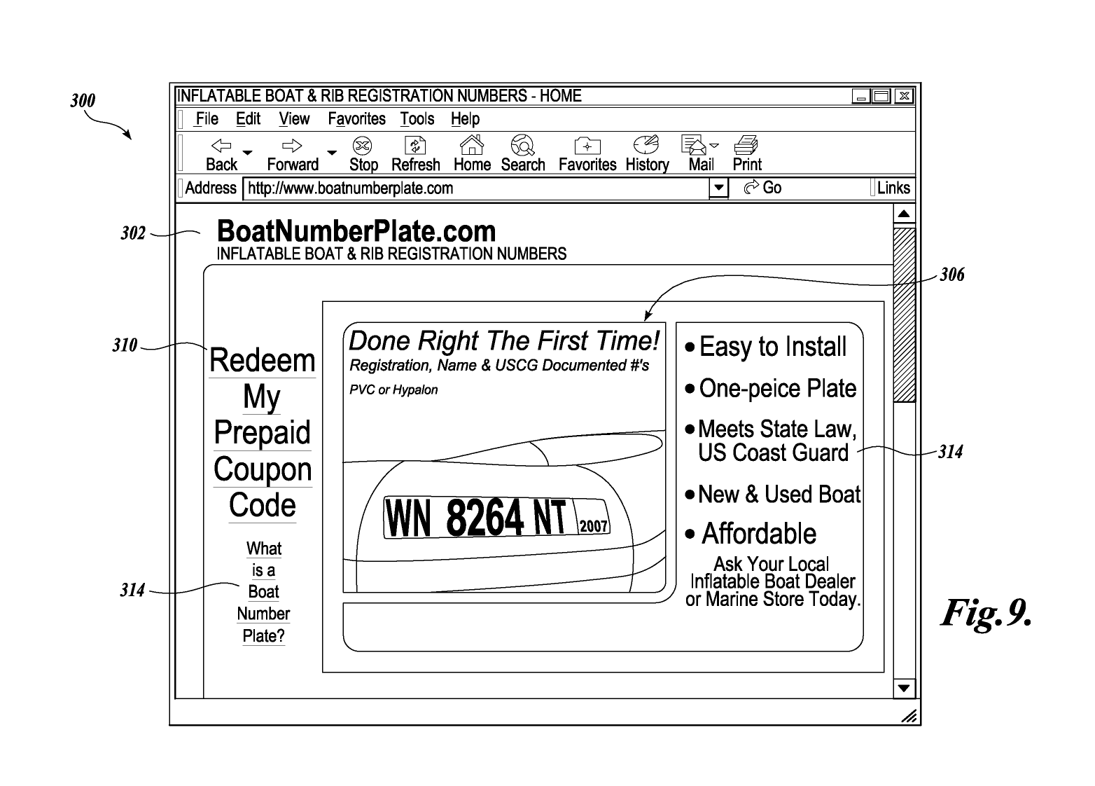

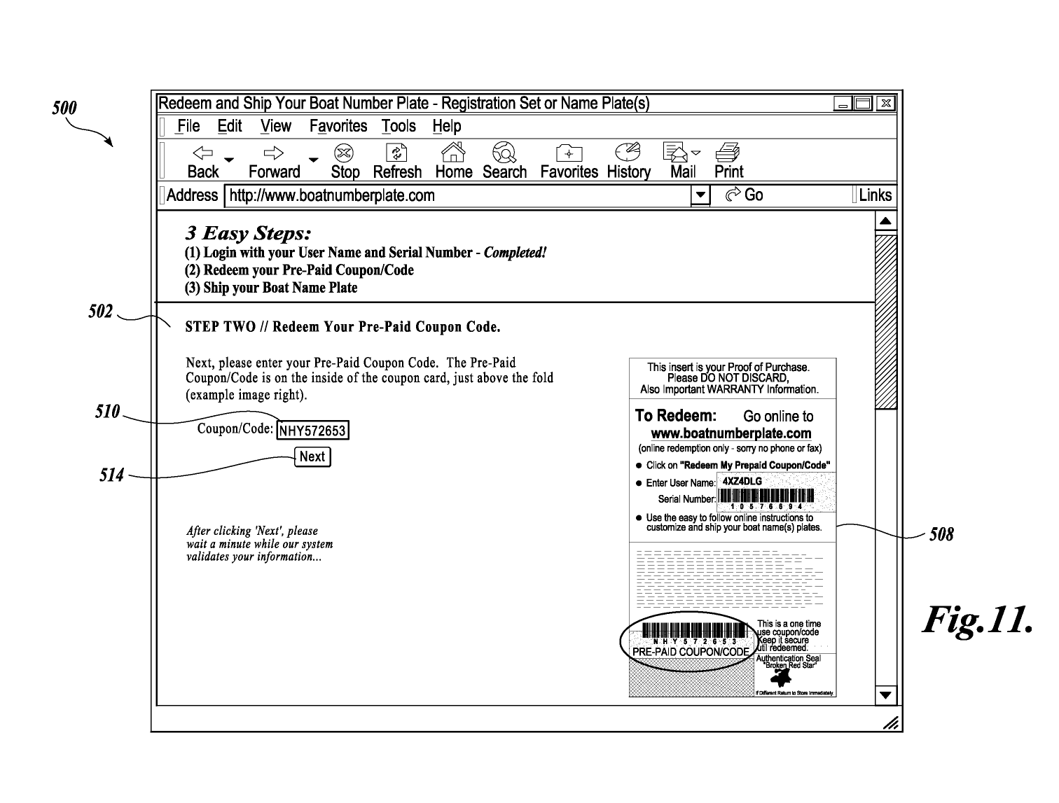

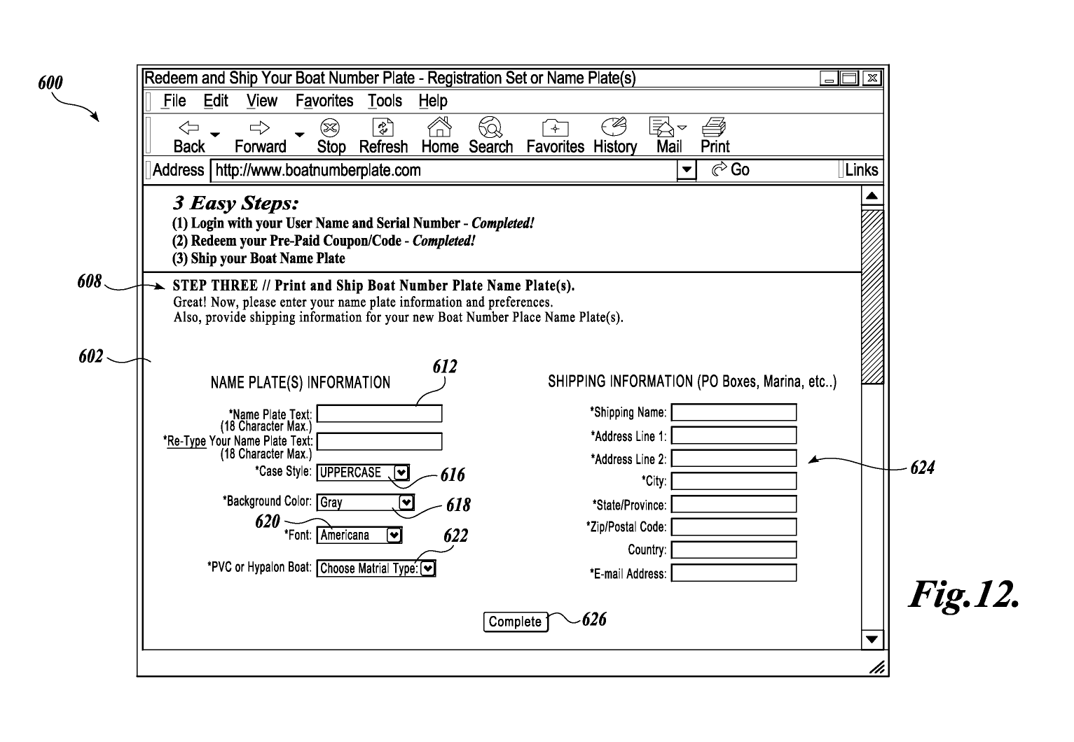

The Web server 208 illustrated in FIG. 7 comprises computer-executable instructions that, when executed by the processor 200, generates configurable markup documents (hereinafter referred to as “Web pages”), such as the sample Web pages depicted in FIGS. 9-12, that are described in more detail below. The Web server program 208 provides a way for the supplier server 184 to interact with users of other network-accessible computers. For example, the Web server program 208 is configured to generate Web pages and cause markup code from Web pages to be accessible from the network 198. When a Web page is accessed, the Web server program 208 may receive data back from a network computer that describes the user's interactions with the Web page. In accordance with one embodiment of the presently disclosed method, the content of the Web pages generated by the Web server program 208 serve as an interface that enables users to redeem a customizable product, such as a boat name plate for an inflatable boat.

The Web server program 208 also interacts with other computer components illustrated in FIG. 7 so that the appropriate data may be obtained from or communicated to a user. For example, a request to redeem a customizable product may be obtained from a user. In this instance, data associated with the request is received at the Web server 208 and forwarded to the database application 210 so that the database 218 may be updated. As described in detail above, the database 218 is responsible for storing data that includes, but is not limited to, the user name 160, the serial number 150, and the coupon code 162 for each packaged coupon 100. In this regard, the database application 210 provides mechanisms for updating and/or retrieving data stored in the database 218 such that a user may redeem the customizable product through a supplier Web site by having the database application 210 authenticate the user name, serial number, and coupon code of the corresponding packaged coupon 100, and thereafter deactivate the user name, serial number, and coupon code of the corresponding packaged coupon 100. The Web server program 218 may also interact with the database application 210 to retrieve data from a backend database 220 that stores the data necessary to provide the Web pages for enabling users to redeem the customizable product. It should be appreciated that the database 218 and backend database 220 may instead be combined into one database, or instead, additional databases may be used.

As further illustrated in FIG. 6, the memory 206 includes an optional reporting module 212 that is responsible for generating administrative reports for retailers that indicate the retailer's inventory of packaged coupons 100. Data that describes the retailer inventory levels of each type of packaged coupons 100 and/or automatic order requirements for the packaged coupons 100 may be collected and stored in database 218. The reporting module 212 retrieves data maintained in the database 218 and provides the data to a retailer that requests that the inventory levels of the packaged coupons 100, the automatic order requirements, or any other data wished to be tracked by the retailer and managed by the supplier.

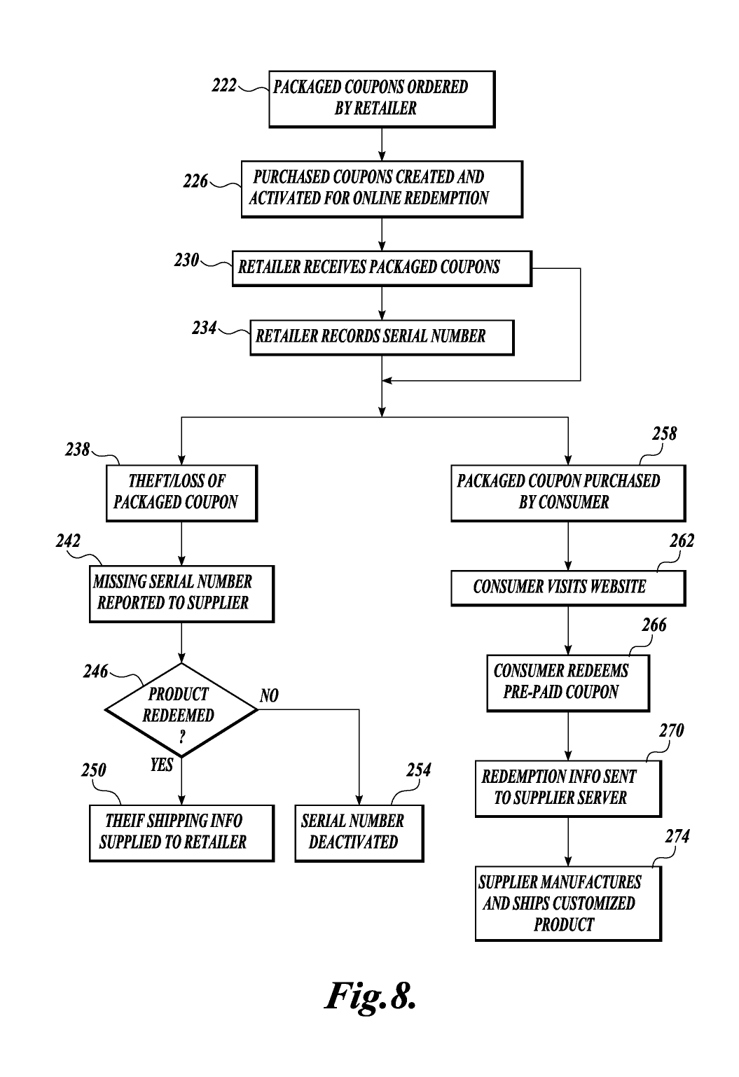

The memory 206 also includes a product redemption routine 214 that implements logic that allows a user to redeem and/or customize the product physically represented by the packaged coupon 100. The product redemption routine 214 is described below with reference to FIGS. 8-12.

Referring now to FIG. 8, an illustrative method of the present disclosure for using the packaged coupon 100 to redeem a customizable product will be hereinafter described. The method begins with block 222 where packaged coupons 100 are ordered by a retailer. At this time, the supplier of the packaged coupons 100 may generate and store the serial number, user name, and coupon code for each packaged coupon 100 in the database 218 shown in FIG. 7. Each insert 104 of the packaged coupons 100 are thereafter printed with the appropriate serial number 150, user name 160, and coupon code 162 and packaged in the clamshell 108, as indicated by block 226. The serial number of each packaged coupon 100 may thereafter be scanned by the supplier to activate the serial number and its associated user name and coupon code in the database 218 for redemption by the consumer, as further indicated by block 226. It should be appreciated that the serial number, user name, and coupon code may instead be generated in advance, and the inserts 104 may be packaged within the clamshell 108 and stored by the supplier until the order is placed by a retailer.

Preferably, the packaged coupons 100 are packaged for shipment with a listing of the serial numbers of the packaged coupons 100. In this manner, when the retailer receives the packaged coupons 100, as indicated by block 230, the retailer may record and use the list of serial numbers for inventory, tracking, and sales purposes, as indicated by block 234. Recording the serial numbers is an optional step for the retailer; thus, after receiving the packaged coupons 100, the retailer may immediately place the packaged coupons 100 on the floor for sale.

With the packaged coupons 100 displayed on the retail floor, the packaged coupon 100 will either be purchased by a consumer, as indicated by block 258, or the packaged coupon 100 may instead be lost or stolen, as indicated by block 238. If the packaged coupon 100 is stolen, the serial numbers of the stolen packaged coupons 100 may be reported to the supplier, as indicated by block 242. This would be possible if the retailer recorded the serial numbers upon receiving the packaged coupons 100, as indicated by block 234, and tracked the serial numbers of the packaged coupons 100 sold. Upon receiving the list of serial numbers for the stolen packaged coupons 100, the supplier may check the database 218 to see if the serial numbers have been inactivated, which would occur if the products have been redeemed, as indicated by decision block 246. If any of the products have been redeemed, the supplier may provide the retailer with the consumer's contact information for the stolen packaged coupon 100, as indicated by block 250. As such, the retailer may report the information to the appropriate authorities. If the product has not yet been redeemed, the serial number and its associated user name and coupon code is deactivated in the database 218, as indicated by block 254, and the retailer can be refunded for the value of the packaged coupon 100 that was stolen.

If the packaged coupon 100 is instead purchased by a consumer, as indicated by block 258, the consumer thereafter visits the supplier Web site to redeem the product physically represented by the packaged coupon 100, as indicated by block 262. Upon visiting the supplier Web site, the consumer redeems the physical product with the packaged coupon 100 by entering the user name 160, serial number 150, and coupon code 162 provided on the inside of the insert 104, by entering any customization information for the product, and by entering the appropriate shipping information, as indicated by block 266 and later described with reference to FIGS. 9-12. After the consumer enters the required information into the supplier Web site, the information is communicated to the supplier server 184, as indicated by block 270, for processing by the supplier server 184. The database 218 of the supplier server 184 is accessed to authenticate the user name, serial number, and coupon code entered by the consumer to validate the packaged coupon 100 and the redemption of the physical product. At the same time or shortly thereafter, the user name, serial number, and coupon code of the redeemed prepackaged coupon 100 are inactivated in the database 218. After receiving the information from the Web site and authenticating the information entered by the consumer, the supplier manufactures and ships the customized product to the consumer, as indicated by block 274.

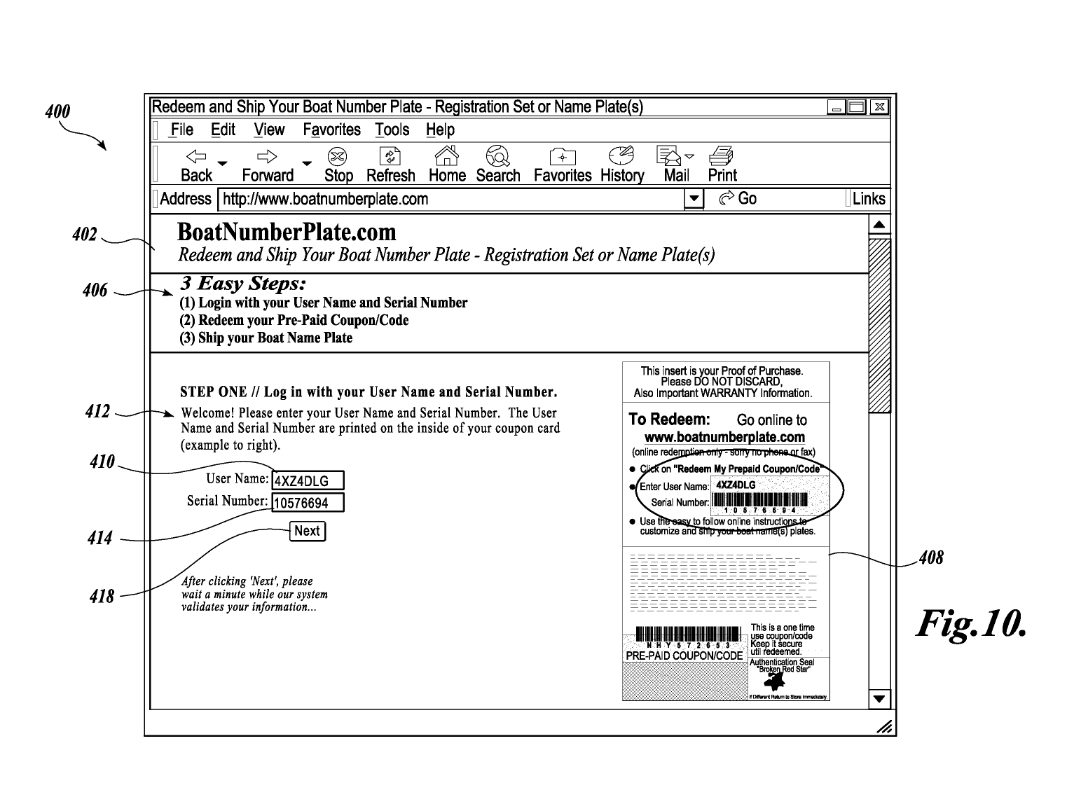

Now referring to FIGS. 9-12, the supplier of the packaged coupons 100 or a third-party manager associated with the supplier server 184 provides a Web site accessible to the client computers 186 and 188 for redeeming the customizable product physically represented by the packaged coupon 100. Referring specifically to FIG. 9, an exemplary Web page 300 that is of the type that may be displayed to the user at block 266 (FIG. 8) and is suitable to carry out aspects of the disclosed method will be described. The exemplary Web page 300 depicted in FIG. 9 includes a display area 302 for presenting graphical information 306 and textual information 314 that describes the product to be redeemed, i.e., a boat name plate. The display area 302 also provides a link 310 that, when activated, enables the user to redeem a boat name plate with the packaged coupon 100. Upon activating the link 310, the user is directed to a second Web page 400 depicted in FIG. 10.

Web page 400 includes a display area 402 having textual instructions for redeeming the boat name plate 406 and a sample insert illustration 408 of a packaged coupon 100 that aid the user in redeeming the boat name plate. The instructions 406 guide the user in redeeming the boat name plate with the Web site. For instance, the instructions 406 of the illustrated embodiment provide steps for redeeming the product by first logging in with a user name and password, then redeeming the prepaid coupon code, and finally providing shipment information for the product. The display area 406 further provides detailed instructions 412 for carrying out the first step, which entails typing a user name into a text box 410 and a serial number into a text box 414, and thereafter activating a NEXT button 418 to direct the user to Web page 500.

Web page 500 includes a display area 502 that displays an insert sample 508 of a packaged coupon for reference. The display area 502 further provides detailed instructions 502 for carrying out the second step, which includes typing the coupon code 162 shown on the packaged coupon 100 into a coupon code text box 510, and thereafter activating a NEXT button 514 to direct the user to a final Web page 600.

The Web page 600 includes a display area 602 having detailed instructions 608 for carrying out the third step, which includes entering the product information and the shipping information. The display area 602 includes numerous text boxes that allow the user to enter specific information for customizing the boat name plate. For instance, the display area 602 may include a text box 612 for entering the boat name text, a text box 616 for entering the case style of the text of the boat name plate, a text box 618 for entering the color of the boat name plate, a text box 620 for entering the font of the boat name plate text, and a text box 622 for entering the type of inflatable boat to which the boat name plate will be affixed (i.e., PVC or Hypalon). The display area 602 may further include a plurality of text boxes 624 that allow the user to enter the shipping information for the boat name plate. For instance, the user may enter his or her name, street address, city, state, and zip code to provide the supplier with the necessary information for shipping the boat name plate. After entering the necessary information into the text boxes shown in the display area 602, the user may activate a COMPLETE button 626 to finalize the redemption of the boat name plate and to communicate the necessary information to the supplier for manufacturing the boat name plate, as indicated in block 270 in FIG. 8. After receiving all of the necessary information from the Web site, the supplier manufactures and ships the boat name plate to the user, as shown in block 274 in FIG. 8.

While illustrative embodiments have been illustrated and described, it will be appreciated that various changes can be made therein without departing from the spirit and scope of the present disclosure.

The embodiments of the present disclosure in which an exclusive property or privilege is claimed are defined as follows:

1. A method of selling a supplier's product to a consumer, the method comprising:
(a) creating a physical representation of a product, the physical representation of a product comprising:
(i) temporarily concealed first, second, and third unique identifiers corresponding to the physical representation of the product;
(ii) a visible fourth unique identifier corresponding to the physical representation of the product;
(b) providing a first computing device in communication with a network location;
(c) processing, by the first computing device, an order for at least one physical representation of a product in exchange for payment of a first predetermined value;
(d) storing, by the first computing device, the fourth unique identifier of each of the at least one physical representation of a product ordered product in an internal listing of unique identifiers in a database of the first computing device;
(e) storing, by the first computing device, the corresponding first, second, and third unique identifiers for the at least one physical representation of a product in the internal listing of unique identifiers in a database of the first computing device;
(f) activating, by the first computing device, the first, second, and third unique identifiers within the database;
(g) providing the at least one physical representation of a product to a retailer;
(h) selling the at least one physical representation to the consumer in exchange for payment of a second predetermined value;
(i) providing, by the first computing device, a network location accessible by a second computing device for facilitating redemption of the product that allows a consumer to:
(i) input the first, second, and third unique identifiers;
(ii) input customizable information about the product; and
(iii) input shipping information for receiving the product;
(j) processing, by the first computing device, the information input by the consumer to authenticate the first, second, and third unique identifiers;
(k) updating, by the first computing device, the internal listing of unique identifiers in the database to reflect the redemption of the product corresponding to the first, second, third, and fourth unique identifiers;
(l) creating and shipping the product to the consumer; and
(m) deactivating, by the first computing device, the first, second, third, and fourth unique identifiers within the database.

2. The method of claim 1, wherein the physical representation comprises an insert temporarily sealed within a package, the first, second, and third unique identifiers displayed on an interior portion of the insert.

3. The method of claim 2, wherein the fourth unique identifier is displayed on an exterior portion of the insert that is visible through the package.

4. The method of claim 1, wherein the retailer creates a listing of the fourth unique identifier of each of the at least one physical representation of a product to track the inventory of the at least one physical representation of a product at the retailer.

5. The method of claim 4, wherein the retailer communicates the listing of fourth unique identifiers to the supplier such that the supplier may track, by the first computing device, the inventory levels of physical representations of a product at the retailer.

6. The method of claim 5, wherein the supplier sends at least one physical representation of a product to the retailer when the inventory level of physical representation of a product at the retailer falls below a predetermined level.

7. The method of claim 1, wherein the retailer provides the supplier with the fourth unique identifier of a corresponding physical representation of a product that is stolen from the retailer, and wherein the supplier, by the first computing device, deactivates the corresponding first, second, and third unique identifiers of the stolen physical representation of a product within the database if the product has not yet been redeemed, and wherein the supplier sends the shipping information of the consumer to the retailer if the product has been redeemed.

8. The method of claim 2, wherein the insert includes an authentication seal displayed on an interior portion of the insert that corresponds to the physical representation.

9. The method of claim 1, wherein the supplier provides the physical representation to a retailer.

10. The method of claim 1, wherein providing a network location to the consumer for facilitating the redemption of the product by the consumer includes generating Web pages that allow a consumer to:
(a) input the first, second, and third unique identifiers;
(b) input the customizable information about the product; and
(c) input the shipping information for receiving the product.

11. The method of claim 1, wherein providing a network location to the consumer for facilitating the redemption of the product by the consumer includes:
(a) providing, by the first computing device, a first input mechanism at the network location that enables the consumer to input the first, second, and third unique identifiers;
(b) providing, by the first computing device, a second input mechanism at the network location that enables the consumer to input the customizable information about the product;
(c) providing, by the first computing device, a third input mechanism at the network location that enables the consumer to input the shipping information for the product; and
(d) receiving, by the first computing device, requests at the first, second, and third input mechanisms to provide the supplier with information for creating and shipping the product.

12. The method of claim 11, wherein the first, second, and third input mechanisms are text boxes embedded on a Web page that are available at the network location.
